(19) United States
(12) Patent Application Publication
(10) Pub. No.: US 2025/0225637 A1
(43) Pub. Date: Jul. 10, 2025

(54) METHOD AND APPARATUS FOR AUTOMATICALLY GRADING USED TERMINALS

(71) Applicant: CDR Eco-Movement, Inc., Tokyo (JP)

(72) Inventors: Toshihiro Sekiguchi, Tokyo (JP); Masahiro Ishizaka, Tokyo (JP); Ayano Imai, Tokyo (JP); Nozomi Harada, Tokyo (JP)

(73) Assignee: CDR Eco-Movement, Inc., Tokyo (JP)

(21) Appl. No.: 18/294,343

(22) PCT Filed: Jul. 14, 2023
(86) PCT No.: PCT/JP2023/026000

§ 371 Date: Feb. 1, 2024

(51) Int. Cl. G06T 7/00

(52) U.S. Cl. CPC G06T 7/0004

(57) ABSTRACT

Appearance inspection of used terminals is improved in accuracy, and this contributes to automatic grading of terminals to be recycled based on highly accurate inspection data obtained through the new inspection mode. A terminal is moved in a plane; a front surface or a back surface of the moving terminal is irradiated with illumination light from diagonally above a rear of the terminal toward a front, and an image of an illuminated part of the terminal is captured with a camera directed from diagonally above the front of the terminal toward the rear; a captured image data is referred to types of reference grade data, each sorted by grade, stored in a database of a server; a grade (rank) of reference grade data, to which the image data is determined to belong, is determined to be a grade of the image data; and the determination result is output.

### TECHNICAL FIELD

The present invention relates to a method and an apparatus for automatically classifying an individual terminal as a new product (hereinafter, also referred to as grading or ranking) using AI (artificial intelligence), based on image data from appearance inspection on the terminal executed in a process of recycling and commercializing used mobile terminals such as smartphones (hereinafter referred to as used terminals or terminals).

### BACKGROUND ART

Conventionally, terminals purchased as used apparatuses have been recycled and commercialized, and techniques that are considered useful for commercializing used terminals have been proposed in Patent Literatures 1 to 3 and the like. However, there is nothing related to automatic grading of used terminals among the proposed literatures.

An outline of the human-centered commercialization process of used terminals that has been conventionally carried out will be explained with reference to FIG. 5.

Used terminals to be commercialized are processed as follows: terminals are removed that are determined to be unsuitable for commercialization from the terminals that have been “in stock” for a commercialization process; the remaining terminals are placed in “acceptance”; and all the terminals placed in the “acceptance” have a next “erasure process” in which the residual data is erased, and are then transferred to an inspection process in which “functional inspection” and “appearance inspection” are performed.

The “functional inspection” and the “appearance inspection” are executed as an inspection process, the inspection results of which is to be used for grading (classifying) the terminal to make the terminal into a recycled product classified in the next “grading” process.

In addition, terminals sorted based on the grading results and other criteria are stored in “inventory shelves” and wait for orders from purchasing companies. When there are orders from a plurality of purchasing companies (purchasers), each terminal is individually packaged and “packed” according to the order details for each purchaser, and each package is “sealed” and then “shipped”.

In the conventional commercialization process shown in FIG. 5, the individual processes are connected by a belt conveyor BC, and each process base is provided with a workbench, temporary storage shelf, tools, etc., and at least one worker is in charge for executing each process.

As mentioned above, in the conventional process of commercializing used terminals, individual processes have been mostly done manually by workers. Therefore, there has been a problem in which variations in work efficiency, work results, or work accuracy are likely to occur due to differences in experience and ability in the individual workers. In particular, in grading based on appearance inspection, although there have been certain criteria, it has been based on subjective determination based on the experience and intuition of workers, which has required time and caused variations in the grades determined.

Regarding the above-mentioned problems, the inventors of the present invention have previously proposed an invention in Japanese Patent Application No. 2022-203406 in which an inspection process including appearance inspection can be automatically executed without manual operation.

The proposed invention is a technique that can execute both the functional inspection and appearance inspection of terminals automatically without manual operation, and grading is also a technique that automatically determines based on inspection data. The technique has enabled to largely solve the problems of the conventional grading with manual operation, but there have been still issues left.

### CITATION LIST

### Patent Literature

### [Patent Literature 1]

Japanese Translation of PCT International Application Publication No. 2022-539909

### [Patent Literature 2]

Japanese Patent No. 5820464

### [Patent Literature 3]

Japanese Patent No. 4171453

### SUMMARY OF INVENTION

### Technical Problem

An object of the present invention is to provide a method: capable of greatly improving inspection accuracy for appearance inspection of used terminals to be commercialized by employing a new imaging mode; and automatically grading terminals to be recycled with AI based on high-accuracy image data obtained by new imaging mode.

The quality of the exterior appearance of a used terminal is determined by whether there are any flaws (scratches, recessed flaws, protruding flaws, etc.) on the front surface (liquid crystal display surface), back surface, outer circumferential surface, or outer corner part of the casing (housing) of the terminal, and how serious the degrees of the flaws are (deep or shallow, high or low, etc.) if there are flaws. Although used terminals may look clean at first glance, many of them have minute flaws (scratches), so there is a need for the development of a technique that can distinctly and clearly image even minute scratches.

Therefore, an object of the present invention is to acquire clear image data even from minute flaws.

### Solution to Problem

A configuration of the present invention that can solve the above problems includes: moving a terminal in a plane; irradiating an outer surface (a front surface or a back surface) of the moving terminal with illumination light from diagonally above a rear of the terminal toward a front in a moving direction of the terminal, and capturing a plurality of images of the illuminated part of the terminal with a camera (hereinafter also referred to as a digital camera or D camera) directed from diagonally above a front of the terminal toward the rear in the moving direction; referring flaw data of the terminal, which is formed by processing the image data, to a plurality of types of reference grade data, each sorted by grade, stored in a database, in a server; determining a grade (rank) of reference grade data, to which the flaw data is determined to belong, to be a grade of the terminal; and outputting the determination result.

In the present invention, there is a mode of acquiring image data of both surfaces of the terminal by: irradiating the terminal being moved with illumination light and capturing an image of the terminal with a D camera when the terminal is moved on a belt conveyor with the front side or the back side facing upward; then reversing the terminal and moving the terminal with the back side or the front side facing upward; and irradiating the terminal with the illumination light and capturing an image of the terminal with a D camera, similarly to the above.

In a specific example of imaging mode, a single conveyor is arranged so as to run in one direction in a horizontal posture, and an image data forming unit (hereinafter referred to as a first image data forming unit) for the front side (or the back side) of the terminal is configured by arranging a light source for illumination and a D camera for imaging in a dark-box-like space on the nearer side in the running direction of the conveyor.

An image data forming unit (hereinafter referred to as a second image data forming unit) for the back side (or front side) of the terminal is arranged on the front side in the running direction of the conveyor in the same configuration as that in the first image data forming unit.

In the conveyor, a reversing mechanism is provided between the first image data forming unit and the second image data forming unit to reverse the terminal being placed and transported on the conveyor.

An example of the reversing mechanism is a mechanism that grips a moving terminal in a horizontal posture, rises, rotates the held terminal at the top dead center by 180 degrees, lowers, and releases the holding on a conveyor, and the reversing mechanism is configured with a grip that has a rising-lowering function and a rotating function with motors serving as the drive sources. The grip may be a gripper of a suction cup type that uses air or a gripper with a mechanical configuration.

Each light source of the illumination light and each D camera configuring the first image data forming unit and the second image data forming unit of the present invention may include an adjustment function that allows a position in the up-down direction and an angle of inclination to be arbitrarily changed. The above-mentioned positions and angles are each automatically adjusted or set based on data of the size and thickness of the terminal that is obtained by imaging the terminal that starts moving with another D camera.

The mechanism for automatically adjusting the positions and angles has substantially the same configurations in the light sources and the D cameras. An example of the mechanism has motors serving as the drive sources. The mechanism also includes linear motion mechanisms, each of which uses a rack and pinion mechanism or a feed screw mechanism to move a target object (the light source or the camera) in a straight line such as rising and lowering, and a rotating mechanisms, each of which changes a set angle of the target object (light source and camera). The control unit of the motors is controlled for rotation based on a control signal supplied from a control unit of the server, so that the linear motions and the rotational motions are controlled for driving.

In the above description, the image data of the front surface and back surface of the terminal is formed in a time-series manner in the first image data forming unit and the second image data forming unit arranged in series on one conveyor. In the present invention, there may be a configuration in which the first image data and the second image data can be formed and acquired simultaneously. This point will be discussed below.

The following is an example of the configuration in which the first image data and the second image data are simultaneously formed and acquired.

First, two conveyors for sending terminals are prepared, and the two conveyors are arranged as a first conveyor and a second conveyor, which are separated by a gap less than the length of one terminal in the running direction.

Next, an upper dark-box-like space and a lower dark-box-like space are formed respectively above and below both the conveyors so as to sandwich the gap between the first conveyor and the second conveyor.

In each of the upper dark-box-like space and the lower dark-box-like space, a light source for illumination and a D-camera for imaging are arranged in the manner described above. As a result, the upper dark-box-like space is configured as the first image data forming unit, and the lower dark-box-like space is configured as the second image data forming unit.

With the above configuration, the first image data and the second image data can be simultaneously formed and acquired in the first image data forming unit and the second image data forming unit arranged so as to sandwich the gap in the up-down direction, which gap is formed between the first conveyor and the second conveyor. This configuration eliminates the need for a terminal reversing mechanism.

The above mechanism that can simultaneously form and acquire the first image data and the second image data can be further developed into a configuration that utilizes mirrors to allow for acquiring image data of the side surfaces of the terminal. This point will be explained below.

Image data of the left and right side surfaces of the terminal (hereinafter referred to as third image data) can be obtained by: arranging mirrors or half mirrors that are inclined at an angle of about 45 degrees with respect to the horizontal plane (conveyor running surface) and respectively face the left and right side surfaces of the terminal being moved, on the left and right sides with respect to the conveyor running direction of the gap set between the first conveyor and the second conveyor in the conveyor running direction; reflecting the mirror images of the side surfaces of the terminal on the mirrors; and imaging the side surfaces of the terminal reflected on the mirrors with the D camera of the first image data forming unit.

### Advantageous Effect of Invention

In the present invention, the grade of flaws on the terminal can be automatically determined with AI based on the determination data because the determination data is obtained by: irradiating the terminal being moved with illumination light having an inclined optical axis toward the terminal; capturing a plurality of images of the terminal, which is illuminated and moved, with a digital camera (D camera), processing the images, and acquiring image data; referring the acquired image data to a plurality of types of reference grade data, each sorted by grade, held in the database; determining the grade of the terminal that brought the acquired image data; and outputting the determined data.

### BRIEF DESCRIPTION OF DRAWINGS

FIG. 1 is a schematic side view for explaining a basic configuration of an image data forming unit of a terminal in an automatic grading system of the present invention.

FIG. 2 is a schematic side view of an image data forming unit including a terminal information forming unit installed in a nearer side of the image data forming unit in FIG. 1 to acquire data regarding a size and a thickness of a terminal.

FIG. 3 is a schematic side view of an image data forming unit configured to allow for simultaneously forming and acquiring image data of a front surface and a back surface of a terminal.

FIG. 4 is a schematic front cross-sectional view for explaining a configuration example in which mirrors are used in an image data forming unit of FIG. 4 to image side surfaces of the terminal.

FIG. 5 is a process diagram for explaining a conventional processes with manual operation for commercializing used terminals.

### DESCRIPTION OF EMBODIMENTS

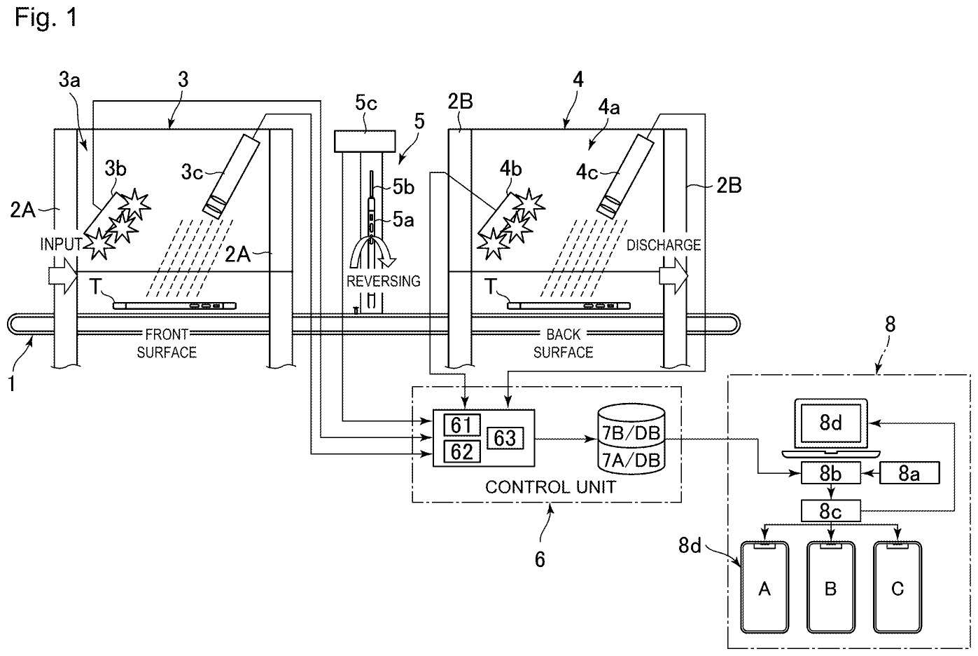

An example of a system that can execute a method for automatically grading of the present invention will be described with reference to FIGS. 1 to 4.

In FIG. 1, a reference numeral 1 denotes a belt conveyor (hereinafter referred to as a conveyor 1) that carries a terminal T and runs at a speed of about 4 m/min. This conveyor 1 is mounted on a frame 2A and a frame 2B at the front and the rear in the running direction (the length direction of the conveyor 1). The conveyor 1 of FIG. 1 is formed of a flexible transportation belt with a length of about 2 m and a width of about 300 to 450 mm. However, the conveyor 1 is not limited to the configuration with the belt having the above numerical values and the frames 2A and 2B that support the belt.

Note that, in this description, in the running direction of the conveyor 1, the nearer side is referred to as a rear side (or a rear part), and the farther side is referred to as a front side (or a front part). Furthermore, in the vertical direction orthogonal to the upper surface of the conveyor 1, the upper side is referred to as an upper side (or an upper part), and the lower side is referred to as a lower side (or lower part).

A reference numeral 3 denotes a first image data forming unit formed on the nearer side (rear side) in the running direction of the conveyor 1. A reference numeral 4 denotes a second image data forming unit, formed on the farther side (front side) in the running direction of the conveyor 1, with the same configuration as the first image data forming unit.

The first image data forming unit 3 and the second image data forming unit 4 have the same configuration, so the following describes the first image data forming unit 3, but the second image data forming unit 4 differs from the first image data forming unit 3 only in the reference characters for members with the same configuration.

The first image data forming unit 3 is configured with an illumination apparatus 3b and a digital camera 3C respectively arranged diagonally above the rear and diagonally above the front of the terminal T, placed on the conveyor 1, in a dark-box-like area 3a supported by two vertical frames 2A, 2A at the front and the rear on the nearer side (rear) of the conveyor 1. Hereinafter, the digital camera 3C is also referred to as a D camera 3c, and the dark-box-like area 3a is also referred to as a dark box area 3a.

Specifically, the illumination apparatus 3b is arranged in such a posture that it can irradiate the terminal T in the dark box area 3a with illumination light from diagonally above the rear. The illumination light is generated by an illumination light source (hereinafter, also referred to as a light source) in which LEDs or the like are arranged in a plane. The D camera 3c is arranged in a posture in which the objective lens faces the terminal T from diagonally above and in front of the terminal T to be illuminated.

Note that, for causing the arrangement posture of the illumination apparatus 3b and the D camera 3c to be adjusted to meet differences in the size and thickness in the up-down direction of the terminal T depending on the type of the terminal T (such as differences in model and manufacturer), some of the illumination apparatuses 3b and the D cameras 3c have a configuration, though not shown, that allows displacement and positioning in the up-down direction, and change and positioning of the inclination angle of the irradiation optical axis and the optical axis of the camera optical system. This point will be described below.

The second image data forming unit 4 has the same configuration as the first image data forming unit 3 described above, and includes: a dark box area 4a disposed in the frames 2B, 2B in front; and an illumination apparatus 4b and a D camera 4c that are arranged inside the dark box area 4a in the same manner as the illumination apparatus 3b and the D camera 3c.

In the apparatus of the present invention shown in FIG. 1, the reversing mechanism 5 for reversing a terminal T on the conveyor is arranged between the rear frame 2A and the front frame 2B of the conveyor 1.

The reversing mechanism 5 holds the terminal T on the conveyor 1 with a suction cup, rises, places the terminal T on a temporary stand at top dead center, and releases the terminal T there. The reversing mechanism 5 then rotates the terminal T on the stand by 180 degrees, holds the terminal T with the suction cup again, lowers, and places the held terminal T on the conveyor 1. The reversing mechanism 5 includes a terminal holder 5a, an elevator 5b having the holder 5a, a temporary stand 5c for temporarily placing and reversing the raised terminal, and a drive mechanism unit with a motor or the like.

As an example, the terminal holder 5a is preferably of a suction cup type, but may be of a mechanical configuration that grips and releases the terminal T by gripping means that opens and closes pneumatically or electromagnetically. The elevator 5b that raises and lowers the terminal holder 5a includes a linear movement mechanism such as an air cylinder mechanism, a feed screw mechanism, or a rack and pinion mechanism. The terminal holder 5a and the elevator 5b are controlled by a third control unit 63 included in the control unit server 6.

The first image data forming unit 4 and the second image data forming unit 4 are controlled to drive by the first and second control units 61 and 62 of the control unit server 6. The first image data forming unit 3 and the second image data forming unit 4 send image data (first image data and second image data) to the control unit server 6, which image data is obtained by processing a plurality of images, captured by the two D cameras 3c and 4c, of the front surface and the back surface of the terminal T.

In other words, the control unit server 6 includes a first control unit 61 that controls the driving of the illumination apparatus 3b and the D camera 3c of the first image data forming unit 3 that images the front side (the flaws thereon) of the terminal T, and a second control unit 62 that controls driving of the illumination apparatus 4b and the D camera 4c of the second image data forming unit 4 that images the back side (the flaws thereon) of the terminal T.

Additionally, the first control unit 61 and the second control unit 62 have the following functions.

In other words, when the terminal T is transported by the conveyor 1 from the input side to the discharge side through the first image data forming unit 3 and the second image data forming unit 4 and a terminal detection sensor (not shown), provided on the frame 2A on the nearer side of the first image data forming unit 3, detects the moving terminal T, the sensor outputs a trigger signal t₁ to the first control unit 61. Next, when a terminal detection sensor (not shown) provided on the frame 2B on the nearer side of the second image data forming unit 4 detects the moving terminal T, the sensor outputs a trigger signal t2 to the second control unit 62.

When receiving the trigger signal t₁, the first control unit 61 puts the illumination apparatus 3b and the D camera 3c of the first image data forming unit 3 into a driving state. When the moving terminal T leaves the angle of view of the D camera 3c, a terminal detection sensor (not shown), provided on the front frame 2A detects the moving terminal T, supplies an end signal e: to the first control unit 61, and the illumination apparatus 3b and the D camera 3c stop operation.

The terminal T, which has been imaged by the first image data forming unit 3, is continuously transported and is detected by the terminal detection sensor provided in the front frame 2A. This detection is the same as the end signal e1, and is sent to the third control unit 63 as a trigger signal t3. In response to the trigger signal t3, the third control unit 63 drives and controls the reversing mechanism 5 to reverse the terminal T. When the reversed terminal T enters the second image data forming unit 4, a trigger signal t2 is generated by a terminal detection sensor (not shown) provided in the frame 2B on the nearer side of the second image data forming unit 4. The end signal e2 is generated when a terminal detection sensor (not shown) provided in the front frame 2B detects the moving terminal T, and is supplied to the second control unit 62. The actions of the trigger signal t2 and the end signal e2 on the second control unit 62 are similar to those on the first control unit 61 described above.

The first control unit 61 and the second control unit 62 analyze and process the image data acquired by the two image data forming units 3 and 4, and form data necessary for automatic grading determination regarding flaws on the front and back surfaces of the terminal T (hereinafter referred to as “flaw data” for convenience of explanation).

The image data of the front surface of the terminal T imaged by the D camera 3c in the first image data forming unit 3 is processed by the first control unit 61, and the image data of the back surface of the terminal T imaged by the D camera 4c in the second image data forming unit 4 is processed by the second control unit 2. Then, the image data of the front surface is stored in the database 7A as flaw data on the front side of the terminal T and the image data of the back surface is stored in the database 7B as flaw data on the back side of the terminal T, each linked to the terminal T.

Regarding the flaws on the front side and the back side of the terminal T, the flaw data obtained by processing the image data of the front surface and the back surface of the terminal T is stored in the databases 7A and 7B. The flaw data is then sent to the grading server 8 in which the flaw data undergoes grading processing with AI to be graded (ranked).

The following describes an example of the processing mode of grading by AI in the grading server 8.

The grading server 8 uses AI to perform grading processing on flaw data regarding flaws on the front and back surfaces of the terminal T to determine the grade of the terminal T.

For this purpose, the grading server 8 first refers the flaw data on the front and back surfaces of the terminal T to reference data regarding “cracks”, to determine whether the terminal T has a “crack”. Next, the terminal T determined to have a crack is determined to be ranked D, the terminal T determined to have no cracks is referred to a plurality of reference data generated in advance based on the degree (size, amount) of scratches (including dents), and is determined to be ranked A, B, or C. In this example, the A rank includes one having no flaws and one having flaws, the degree of which are extremely small.

For the above-mentioned determination, here, the data serving as the reference for the determination of the above-mentioned ranks A to D is learned by the AI as reference grade data and is stored in the database 8a. In addition, the terminal T having a damage larger than a crack will be ranked D- by visual inspection by the person in charge of inspection. The image data of cracks can be acquired with approximately 100% probability by adjusting the illuminations 3b, 4b and the cameras 3c, 4c of the first and second image data forming units 3, 4.

In the present invention, the number of grade ranks and the contents of the data that serve as the references for each grade determination to be learned can both be set in any manner, and the aspect of the implementation described above is an example.

The flaw data is obtained by processing the image data of the front and back surfaces of the terminal T from the databases 7A and 7B of the control unit server 6 as described above, and is sent to the arithmetic processing unit 8b of the grading server 8. The arithmetic processing unit 8b sequentially refers the sent flaw data to a plurality of types of reference grade data generated by AI in the database 8a, to determine the grade (rank) of the terminal T. This determination signal is output as ranking data (grading data) from the output unit 8c. The output determination signal is displayed as the grade (rank) of the terminal T on the display unit 8d. FIG. 1 schematically shows an example in which three levels of A, B, and C are displayed as the grade of the terminal T on the display unit 8d.

The flaw data obtained by processing the image data of the terminal T, which has been subjected to arithmetic processing to be determined in grade and ranked, can be added to the reference grade data of the same rank in the database Sa. When the flaw data of each grade formed and determined from actual image data is added to the reference grade data, the amount of data of each grade increases and the determination accuracy improves.

In the above explanation, the control unit server 6 and the grading server 8 have been explained as separate servers, but it is also possible to have a configuration in which a single server computer takes charge of the roles and functions of the two servers 6 and 8.

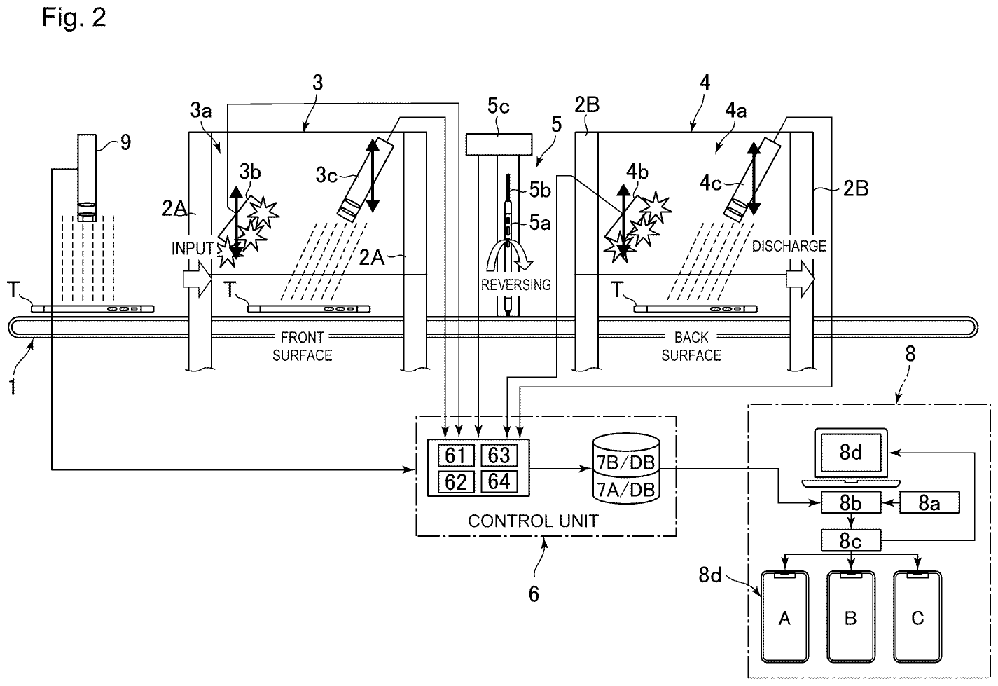

Next, another example of the apparatus of the present invention in FIG. 2 will be described.

In the grading process based on the appearance inspection of used terminals, there are two types: appearance inspection of a single model and grading based on the results; and appearance inspection of terminals T including different models that coexist and grading based on the results.

The embodiment of the apparatus of the present invention described above with reference to FIG. 1 is mainly concerned with appearance inspection of a single model and grading based on the inspection results. In contrast, FIG. 2 shows an outline of an apparatus for executing appearance inspection and grading when different models coexist.

Note that the apparatus of FIG. 1 can be applied to different models as long as they are of similar size. In this respect, the apparatus of FIG. 2 is independent of the size of the terminal T.

The apparatus of FIG. 2 has a first image data forming unit 3, a second image data forming unit 4, and a reversing mechanism 5 each having the same configuration as the apparatus of FIG. 1. The apparatus of FIG. 2 differs from the apparatus shown in FIG. 1 in that the length of the conveyor 1 is longer and a third camera is specially installed.

First, the conveyor 1 used is longer than the conveyor 1 shown in FIG. 1 on the rear side in the running direction. The configuration has a long part on the rear side that has a third digital camera 9 (also referred to as D camera 9) specially arranged. The D camera 9 images the size (length and width in the feeding direction) and thickness (height in the up-down direction orthogonal to the running surface of the conveyor 1) of the terminal T placed on the conveyor 1.

The specially installed D camera 9 is arranged on a frame (not shown) that supports the conveyor 1, images the terminal T moving almost directly below the camera 9, and sends the image data to the fourth control unit 64 of the control unit server 6. The fourth control unit 64 obtains the size and thickness of the terminal T from the image data. Then, based on the obtained size data and thickness data, the fourth control unit 64 outputs signals for adjusting the positions of the illumination apparatuses and the cameras in the height direction and adjusting the inclination angles of the optical axes of the illumination apparatuses and the cameras, to the first control unit 61 for the illumination apparatus 3b and D camera 3c of the first image data forming unit 3, and to the second control unit 62 for the illumination apparatus 4b and D camera 4c of the second image data forming unit 4. Adjustments of the positions and inclination angles is controlled by first and second control units 61 and 62.

The position and inclination angle adjusted and set as described above are canceled and returned to the original position and angle when the terminal T leaves the second image data forming unit 4 (out of the angle of view of the D camera 4c). Note that it goes without saying that the apparatus shown in FIG. 2 can also handle and process a single model. In the case of a single model, the system of the D camera 9 is turned off.

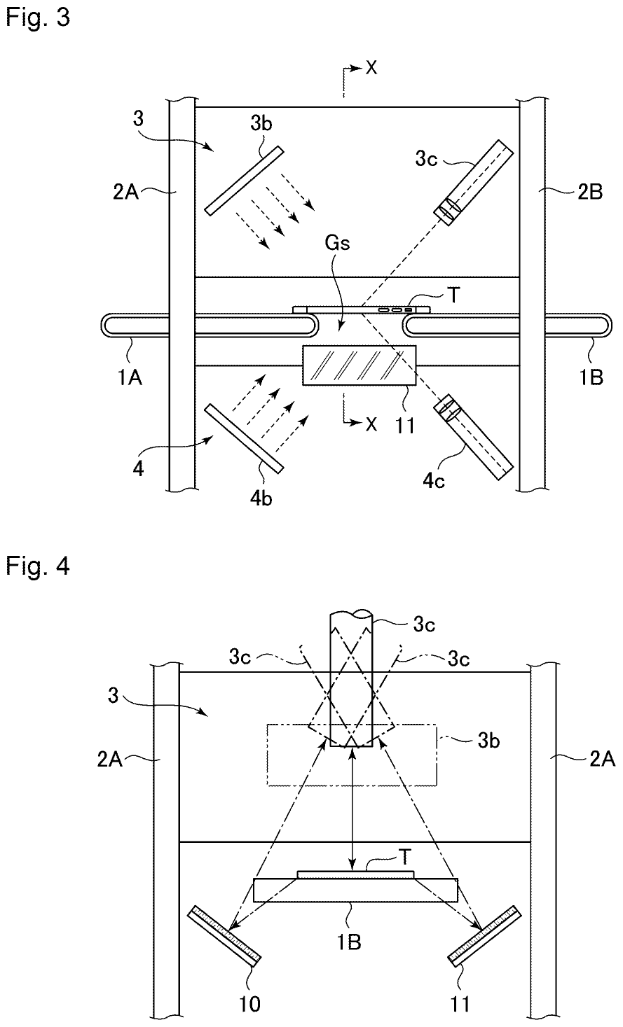

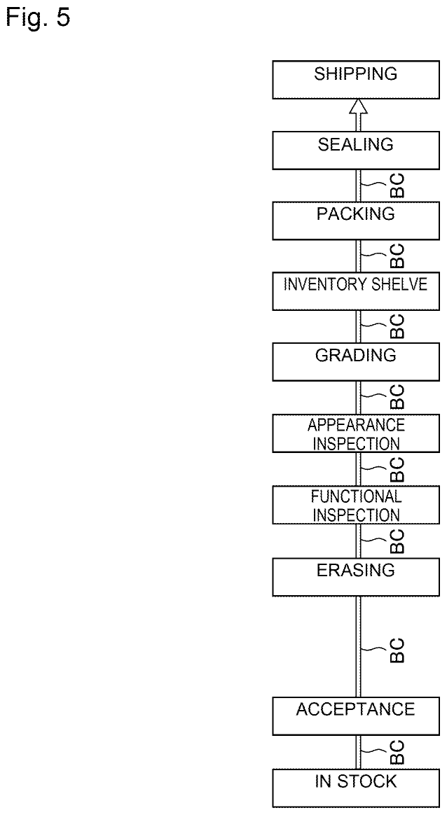

FIG. 3 is a side view schematically showing a third embodiment of the apparatus of the present invention in which the first image data forming unit 3 and the second image data forming unit 4 are arranged so as to sandwich a gap Gs respectively from above and below, which gap is formed between the two conveyors 1A and 1B arranged in series.

In FIG. 3, the conveyors 1A and 1B arranged in series with the gap Gs are mounted and supported on the frames 2A and 2B, and is arranged so as to run from the left to the right in FIG. 3 with the terminal T placed on the upper surface.

The gap Gs formed between the two conveyors 1A and 1B is set to a width corresponding to substantially the entire length of the terminal T in the running direction. To allow the terminal T being carried on the conveyor 1A to transfer from the conveyor 1A to the conveyor 1B without falling from the gap Gs, a rail-shaped support member (not shown) is arranged to support the side edges (left and right side edges with respect to the running direction) of the terminal T from below, as an example.

With respect to the conveyors 1A and 1B arranged with the above-mentioned gap Gs in between, a first image data forming unit 3 and a second image data forming unit 4 each in a dark-box-like space are supported by the frames 2A and 2B and arranged respectively above and below so as to sandwich the gap Gs.

Similar to the previous embodiment, the first image data forming unit 3 and second image data forming unit 4 are provided with illumination apparatuses 3b and 4b that irradiate the front surface and the back surface of the terminal T with illumination light, and D cameras 3c and 4c that image the illuminated surfaces.

The configuration in FIG. 3 differs from the configuration of the first image data forming unit 3 and the second image data forming unit 4 described with reference to FIGS. 1 and 2. The differences are as follows: the data forming units 3 and 4 are arranged respectively above and below so as to sandwich the gap Gs formed by the two conveyors 1A and 1B; and, as shown in FIG. 4, two mirrors 10 and 11 are provided diagonally below the left and right sides of the gap Gs at symmetrical inclination angles. In FIG. 3, the mirrors 10 and 11 are arranged in the second image data forming unit 4.

With the mirrors 10 and 11 arranged, the D camera 3c can turn its head for positioning to capture the images of the side surfaces of the terminal T reflected on the mirrors 10 and 11 (see FIG. 4).

In other words, in the example of FIG. 3, the D camera 3c of the first image data forming unit 3 can acquire image data of three surfaces in total: the front surface of the terminal T and both left and right side surfaces of the terminal T.

The above two mirrors 10 and 11 are arranged in the second image data forming unit 4, but in the present invention, they can also be arranged on the side of the first image data forming unit 3 in a symmetrical direction with respect to the conveyors 1A and 1B.

In this case, both sides of the terminal T will be imaged by the D camera 4c of the second image data forming unit 4. Note that the imaging of both side surfaces of the terminal T is executed as the next process after the imaging of the front and back surfaces of the terminal T is completed.

As described above, the apparatus of the present invention of the third embodiment can simultaneously image flaws on the front surface and the back surface of the terminal T, and has a configuration such that mirrors 10 and 11 are arranged to allow for imaging flaws also on the side surfaces of the terminal T. This is effective in increasing the accuracy of appearance inspection.

### INDUSTRIAL APPLICABILITY

The present invention is as described above, allowing for automatically grading the terminal regarding flaws thereon by: configuring means for inspecting the state of flaws on the front surface and back surface of used terminals so as to irradiate the terminal being moved with illumination light having an inclined optical axis, capture a plurality of images of the illuminated terminal with a digital camera (D camera), and process the image to acquire the image data; and referring the acquired image data to a plurality of types of model data held in the database, to determine the grade of the terminal that has brought the acquired image data.

In addition, since the flaw data, the grade of which has been determined, can be added to the stored reference grade data, allowing for further improvement of the accuracy of the grading determination.

### REFERENCE SIGNS LIST

1 conveyor
2A, 2B frame
3 first image data forming unit
3a dark box area
3b illumination apparatus
3c digital camera (D camera)
4 second image data forming unit
4a dark box area
4b illumination apparatus
4c digital camera (D camera)
5 reversing mechanism
6 server
61 first control unit
62 second control unit
63 third control unit
7A, 7B database
8 grading server
8a database
8b arithmetic processing unit
8c output unit
8d display unit

1. A method for grading a used terminal, comprising:
moving a terminal in a plane;
irradiating a front surface or a back surface of the moving terminal with illumination light from diagonally above a rear of the terminal toward a front, and capturing an image of an illuminated part of the terminal with a camera directed from diagonally above a front of the terminal toward the rear;
referring image data of the terminal to a plurality of types of reference grade data, each sorted by grade, stored in a database of a server, the image data of the terminal being formed by processing the image;
determining a grade (rank) of reference grade data, to which the image data is determined to belong, to be a grade of the image data; and
outputting the determination result.

2. The method for grading a used terminal according to claim 1, wherein
image data of both a front surface and a back surface of the terminal is acquired by:
irradiating the terminal being moved with the illumination light and capturing an image of the terminal with the camera when the terminal is moved on a belt conveyor with the front surface or the back surface facing upward;
then reversing the terminal and moving the terminal with the back surface or the front surface facing upward; and
irradiating the terminal with another illumination light and capturing an image of the terminal with another camera.

3. An image data acquisition apparatus to be used in the method of grading according to claim 2, the apparatus comprising:
a single conveyor arranged so as to run in one direction in a horizontal posture;
a first image data forming unit provided on a nearer side in a running direction of the conveyor, the first image data forming unit being a forming unit for forming image data of a front surface or a back surface of a terminal, the first image data forming unit being configured by arranging an illumination apparatus (hereinafter referred to as a light source) and a camera for imaging in a dark-box-like space; and
a second image data forming unit provided on a front side in the running direction of the conveyor, the second image data forming unit being a forming unit for forming image data of the back surface or the front surface of the terminal, the second image data forming unit being configured by arranging a light source and a camera that are of the same types as the light source and the camera in the configuration of the first image data forming unit.

4. The image data acquisition apparatus according to claim 3, wherein the conveyor includes a reversing mechanism, between the first image data forming unit and the second image data forming unit, for reversing the terminal being placed and transported on the conveyor.

5. The image data acquisition apparatus according to claim 4, wherein the reversing mechanism is configured with a grip having a rising-lowering function and a rotating function using a motor serving as a drive source, the grip gripping the moving terminal in a horizontal posture and rotating the gripped terminal by 180 degrees with respect to a horizontal plane.

6. The image data acquisition apparatus according to claim 3, wherein each light source of illumination light and each camera configuring the first image data forming unit and the second image data forming unit have an adjustment function that allows a position in an up-down direction and an angle of inclination to be arbitrarily changed.

7. An image data acquisition apparatus, comprising:
another camera provided at a position where a terminal starts moving on a conveyor; and
a mechanism that adjusts and sets positions and angles of light sources and cameras in claim 6, wherein
the other camera captures an image of a terminal that is placed on the conveyor to start moving, and
the mechanism adjusts and sets the positions and the angles of the light sources and the cameras based on data of a size and a thickness of the terminal, the data being obtained from image data of the image.

8. The image data acquisition apparatus according to claim 7, wherein the mechanism, which adjusts and sets positions and angles of the light sources and the cameras, uses motors serving as drive sources, and includes linear motion mechanisms and rotation mechanisms, the linear motion mechanisms respectively raising and lowering the light sources and the cameras to position the light sources and the cameras with rack and pinion mechanisms, or feed screw mechanisms or cylinder mechanisms, the rotation mechanisms respectively changing set angles of the light sources and the cameras to position the light sources and the cameras.

9. The image data acquisition apparatus according to claim 3, further comprising a first conveyor and a second conveyor composed of two conveyors arranged in series with a gap less than a length of the terminal in the running direction, instead of a single conveyor for sending the terminal, wherein
a first image data forming unit is arranged above the gap and a second image data forming unit is arranged below the gap, so as to sandwich the gap between the first conveyor and the second conveyor, and when the terminal passes through the gap, the first image data forming unit and the second image data forming unit are simultaneously operated to acquire a first image data and a second image data simultaneously.

10. The image data acquisition apparatus according to claim 9, wherein the image data acquisition apparatus, which simultaneously acquires the first image data and the second image data, acquires image data of left and right side surfaces of the terminal by:
arranging mirrors on left and right sides of the gap set between the first conveyor and the second conveyor, the mirrors being each inclined at an angle of approximately 45 degrees with respect to a horizontal plane so as to respectively face left and right side surfaces of the terminal being moved;
reflecting the side surfaces of the moving terminal on the mirrors; and
capturing mirror images of the side surfaces of the terminal reflected on the mirrors with a camera of the first image data forming unit.
